(19) United States
(12) Patent Application Publication
(10) Pub. No.: US 2024/0325974 A1
(43) Pub. Date: Oct. 3, 2024

(54) SYSTEMS AND METHODS FOR OBTAINING NITROGEN AND CARBON DIOXIDE FROM A FLUE GAS

(71) Applicant: American Ag Energy, Inc., Cambridge, MA (US)

(72) Inventors: Allison Nicole CHOI, Somerville, MA (US); Adam John STROHM, Weymouth, MA (US); Richard Herbert ROSEN, Belmont, MA (US); Wei Han LIM, Methuen, MA (US)

(73) Assignee: American Ag Energy, Inc., Cambridge, MA (US)

(21) Appl. No.: 18/620,671

(22) Filed: Mar. 28, 2024

Related U.S. Application Data
(60) Provisional application No. 63/492,999, filed on Mar. 29, 2023.

(51) Int. Cl. B01D 53/86; B01D 53/22; E21B 41/00

(52) U.S. Cl. CPC B01D 53/8628; B01D 53/226; B01D 53/229; B01D 53/8696; E21B 41/0064; B01D 2251/2062; B01D 2251/2067; B01D 2255/1021; B01D 2255/20738; B01D 2255/20761; B01D 2255/50; B01D 2257/102; B01D 2257/404; B01D 2257/504; B01D 2257/80; B01D 2258/0283

(57) ABSTRACT

Provided are systems and methods for obtaining nitrogen and carbon dioxide gases from a flue gas. A method according to some embodiments comprises receiving a flue gas at an inlet of a selective catalytic reduction system, wherein the flue gas comprises one or more NOₓ gases; reducing the one or more NOₓ gases to N₂ gas in the selective catalytic reduction system; receiving an output gas from the selective catalytic reduction system at an inlet of a gas separation membrane; and separating the output gas into a retentate and a permeate using the gas separation membrane, wherein the retentate comprises N₂ gas.

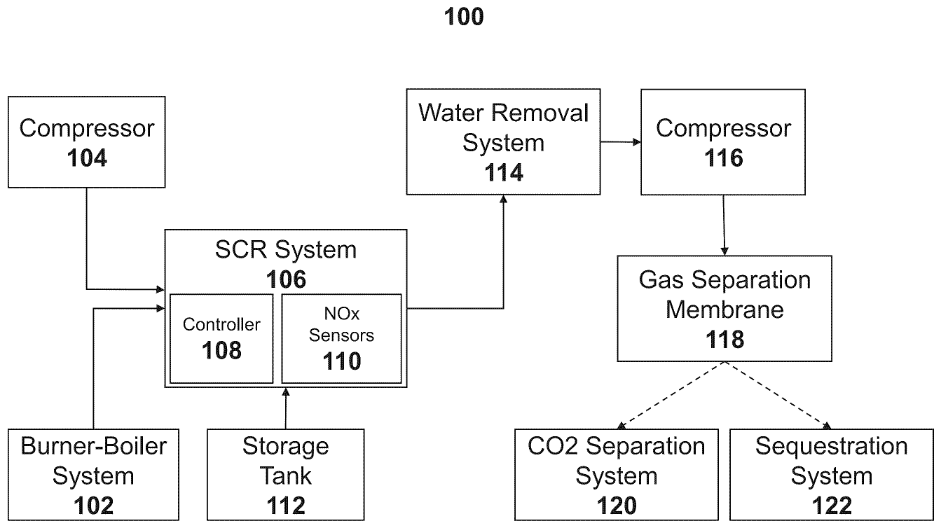

### CROSS-REFERENCE TO RELATED APPLICATIONS

This application claims the benefit of U.S. Provisional Application No. 63/492,999, filed Mar. 29, 2023, the entire contents of which are hereby incorporated by reference herein.

### FIELD

This invention relates generally to isolating components of a gas mixture, and more specifically to systems and methods for obtaining nitrogen and carbon dioxide gases from a flue gas.

### BACKGROUND

Industrial combustion processes produce flue gases containing reaction byproducts such as carbon dioxide, water, and other gaseous compounds. Some of the reaction byproducts may be undesirable pollutants. For example, since some combustion processes are performed using ambient air rather than pure oxygen, nitrogen from the air may react with oxygen to form nitrogen oxide (NOₓ) gases. NOₓ gases can be harmful to human health and the environment, so it is desirable to remove them from a flue gas before releasing it into the atmosphere.

### SUMMARY

Flue gases produced by combustion processes can contain harmful reaction byproducts, such as NOₓ gases. If released into the atmosphere without being reduced to inert nitrogen gas, NOₓ gases can have detrimental health effects and harm the environment. The harmful potential of NOₓ gases can be eliminated by reducing the NOₓ to nitrogen (N₂) gas. N₂ gas has numerous applications in fields such as the chemical, food, and medical industries. Therefore, it can be desirable to develop systems and methods for obtaining N₂ gas from a NOₓ-containing flue gas.

Furthermore, CO₂ may be present in the flue gas. CO₂ is a greenhouse gas that, if released into the atmosphere, can be harmful to the environment. CO₂ also has several industrial and food-grade uses. Therefore, it can also be desirable to develop systems and methods for obtaining CO₂ gas from the flue gas. Disclosed herein are exemplary systems and methods for obtaining nitrogen and carbon dioxide gases from a flue gas.

In some embodiments, a method for obtaining nitrogen gas from a flue gas includes receiving a flue gas at an inlet of a selective catalytic reduction system, wherein the flue gas comprises one or more NOₓ gases; reducing the one or more NOₓ gases to N₂ gas in the selective catalytic reduction system; receiving an output gas from the selective catalytic reduction system at an inlet of a gas separation membrane; and separating the output gas into a retentate and a permeate using the gas separation membrane, wherein the retentate comprises N₂ gas. In some embodiments, a source of the flue gas is a pyrolysis gas, a biogas, or a natural gas. In some embodiments, the method includes burning methane gas in a burner-boiler system; producing a flue gas; and transmitting the flue gas to the inlet of the selective catalytic reduction system. In some embodiments, the flue gas comprises one or more of NOₓ, N₂, CO₂, CO, H₂O, O₂, CH₄, C₂H₆, Ar, SOx, or volatile organic compounds. In some embodiments, the selective catalytic reduction system comprises a reducing agent. In some embodiments, the reducing agent comprises ammonia or urea. In some embodiments, the selective catalytic reduction system comprises one or more catalysts. In some embodiments, the one or more catalysts comprise a copper zeolite catalyst, an iron zeolite catalyst, or a platinum-based oxidation catalyst. In some embodiments, the selective catalytic reduction system comprises a controller. In some embodiments, the selective catalytic reduction system comprises one or more NOₓ sensors, wherein the NOₓ sensors determine a NOₓ content of the output gas from the selective catalytic reduction system. In some embodiments, the controller is configured to adjust a flow rate of the reducing agent based on the determined NOₓ content from the one or more NOₓ sensors. In some embodiments, the method includes compressing the output gas from the selective catalytic reduction system into a compressed output; removing water from the compressed output; and receiving the compressed output at an inlet of the gas separation membrane. In some embodiments, the gas separation membrane comprises a hollow fiber membrane. In some embodiments, the retentate comprises at least 85% wt. N₂. In some embodiments, the permeate comprises at least 35% wt. CO₂. In some embodiments, the permeate comprises one or more of N₂, CO₂, CO, CH₄, C₂H₆, H₂O, Ar, O₂, or NOₓ. In some embodiments, the method includes sequestering the permeate into a ground injection site. In some embodiments, the method includes separating the permeate into a CO₂ stream and a waste gas stream. In some embodiments, separating the permeate into a CO₂ stream and a waste gas stream comprises: receiving the permeate at an inlet of a CO₂-selective gas separation membrane, and separating the permeate into a waste gas stream comprising a CO₂-poor retentate and a CO₂ stream comprising a CO₂-rich permeate using the CO₂-selective gas separation membrane, wherein the CO₂-rich permeate comprises CO₂ gas. In some embodiments, the CO₂-rich permeate comprises at least 92% wt. CO₂. In some embodiments, the method includes removing SOₓ from the flue gas, wherein removing SOₓ from the flue gas comprises wet scrubbing or dry scrubbing. In some embodiments, the method includes removing dust from the flue gas, wherein removing dust from the flue gas comprises using one or more baghouses, one or more ceramic filters, or one or more electrostatic precipitators. In some embodiments, the method includes removing water from the output gas from the selective catalytic reduction system; compressing the output gas into a compressed output; and receiving the compressed output at an inlet of the gas separation membrane.

In some embodiments, a system for obtaining nitrogen gas from a flue gas includes a selective catalytic reduction system configured to: receive a flue gas at an inlet of the selective catalytic reduction system, wherein the flue gas comprises one or more NOₓ gases; and reduce the one or more NOₓ gases to N₂ gas; and a gas separation membrane configured to: receive an output gas from the selective catalytic reduction system at an inlet of the gas separation membrane; and separate the output gas into a retentate and a permeate, wherein the retentate comprises N₂ gas. In some embodiments, the system includes a compressor configured to: receive the output gas from the selective catalytic reduction system at an inlet of the compressor; and compress the output gas from the selective catalytic reduction system into a compressed output. In some embodiments, the system includes a water removal system configured to: receive the compressed output at an inlet of the water removal system; remove water from the compressed output; and transmit the compressed output from an outlet of the water removal system to an inlet of the gas separation membrane. In some embodiments, the system includes a burner-boiler system configured to: produce the flue gas; and transmit the flue gas to an inlet of the selective catalytic reduction system. In some embodiments, the system includes a water removal system configured to: receive the output gas from the selective catalytic reduction system at an inlet of the water removal system; and remove water from the output gas from the selective catalytic reduction system to produce a dried output gas. In some embodiments, the system includes a compressor configured to: receive the dried output gas at an inlet of the compressor; compress the dried output gas into a compressed output; and transmit the compressed output from an outlet of the compressor to an inlet of the gas separation membrane.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

It is understood that aspects and embodiments described herein include “consisting” and/or “consisting essentially of” aspects and embodiments. For all methods, systems, compositions, and devices described herein, the methods, systems, compositions, and devices can either comprise the listed components or steps, or can “consist of” or “consist essentially of” the listed components or steps. When a system, composition, or device is described as “consisting essentially of” the listed components, the system, composition, or device contains the components listed, and may contain other components which do not substantially affect the performance of the system, composition, or device, but either do not contain any other components which substantially affect the performance of the system, composition, or device other than those components expressly listed; or do not contain a sufficient concentration or amount of the extra components to substantially affect the performance of the system, composition, or device. When a method is described as “consisting essentially of” the listed steps, the method contains the steps listed, and may contain other steps that do not substantially affect the outcome of the method, but the method does not contain any other steps which substantially affect the outcome of the method other than those steps expressly listed.

In the disclosure, “substantially free of” a specific component, a specific composition, a specific compound, or a specific ingredient in various embodiments, is meant that less than about 5%, less than about 2%, less than about 1%, less than about 0.5%, less than about 0.1%, less than about 0.05%, less than about 0.025%, or less than about 0.01% of the specific component, the specific composition, the specific compound, or the specific ingredient is present by weight. Preferably, “substantially free of” a specific component, a specific composition, a specific compound, or a specific ingredient indicates that less than about 1% of the specific component, the specific composition, the specific compound, or the specific ingredient is present by weight.

Additional advantages will be readily apparent to those skilled in the art from the following detailed description. The examples and descriptions herein are to be regarded as illustrative in nature and not restrictive.

### BRIEF DESCRIPTION OF THE FIGURES

The single FIGURE is a process flow diagram representing a system for obtaining nitrogen and carbon dioxide gases from a flue gas, in accordance with some embodiments.

### DETAILED DESCRIPTION

Described herein are exemplary systems and methods for obtaining nitrogen and carbon dioxide gases from a flue gas. The systems and methods described herein may address the problems described above. Specifically, the system can reduce harmful NOₓ gases to inert nitrogen gas that may then be separated and used in other processes. In addition, the systems disclosed herein can isolate CO₂ gas that may also be purified and used in other processes.

The single FIGURE is a process flow diagram representing an exemplary system 100 for obtaining nitrogen and carbon dioxide gases from a flue gas. The system can include a burner-boiler system 102, a first compressor 104, a selective catalytic reduction system 106 with a controller 108 and NOₓ sensors 110, a storage tank 112, a water removal system 114, a second compressor 116, a gas separation membrane 118, a CO₂ separation system 120, and/or a sequestration system 122.

In some embodiments, a flue gas can be produced by a burner of burner-boiler system 102 by burning a pyrolysis gas, biogas, and/or methane gas with combustion air. As used in this application, flue gas can refer to any waste gas stream containing combustion products. In some embodiments, the flue gas may comprise one or more of NOₓ, N₂, CO₂, CO, H₂O, O₂, CH₄, C₂H₆, Ar, SOₓ, and/or volatile organic compounds.

In some embodiments, a pyrolysis gas is burned in a burner of burner-boiler system 102. The pyrolysis gas may be produced using a biomass input. As used in this application, biomass input can refer to a biologically derived material. In some embodiments, the biomass input may comprise woody biomass such as wood chips or sawdust; agricultural wastes such as grape vine trimmings, oat and rice hulls, or wheat and oat straw; sewage waste; or combinations thereof. In some embodiments, methane gas is burned in a burner of burner-boiler system 102. In some embodiments, the resulting flue gas may be fed from an outlet of a boiler of burner-boiler system 102 to an inlet of selective catalytic reduction system 106. In some embodiments, the boiler of burner-boiler system 102 may have a power rating of about 0.01-50 MW, about 0.1-25 MW, about 0.2-10 MW, about 0.3-5 MW, about 0.4-1 MW or about 0.5 MW.

In some embodiments, before being fed to selective catalytic reduction system 106, the flue gas from burner-boiler system 102 can be about 0.1-10 psig, about 1-10 psig, about 2-9 psig, about 4-6 psig, or about 5 psig. In some embodiments, the flue gas can be about 10-1000° C., about 50-500° C., about 100-400° C., about 150-350° C., or about 200-300° C.

In some embodiments, the flue gas from burner-boiler system 102 can be pre-processed before being fed to selective catalytic reduction system 106 to collect and remove dust or reduce SOₓ gases. Dust may be present in the flue gas if a solid fuel is burned in the burner of burner-boiler system 102. SOₓ may be present in the flue gas if the fuel burned in burner-boiler system 102 has a significant sulfur quantity. Collecting and subsequently removing dust or reducing SOₓ gases may improve the functioning of gas separation membrane 118. Dust can deposit on the membrane or in the pores, which can cause fouling of the membrane. SOₓ can react with the polymers used to create gas separation membrane 118, which can impair membrane function. Thus, eliminating dust and SOₓ can prevent membrane fouling. Additionally, removing SOₓ may improve the functioning of selective catalytic reduction system 106. SOₓ can react with ammonia or urea to form salts that can foul the catalysts used in selective catalytic reduction system 106.

In some embodiments, dust can be collected with one or more baghouses. A baghouse may comprise one or more fabric bag filters which are permeable by gases, but which prevent dust from passing through the filters. In some embodiments, dust can be collected with one or more ceramic filters. A ceramic filter may be permeable by gases but may prevent dust from passing through the filter. In some embodiments, dust can be collected with one or more electrostatic precipitators (ESPs). An ESP may include electrodes that produce an ionized field. The flue gas may flow through the ionized field, which may negatively charge dust particles in the flue gas. Additional positively charged electrodes may be placed within the ionized field to attract the negatively charged dust particles, which may then be collected from the positively charged electrodes.

In some embodiments, SOₓ gases in the flue gas can be reduced using wet scrubbing techniques. In wet scrubbing, the flue gas may pass through a wetted surface or be sprayed with water. The water may react with the SOₓ gases to produce sulfuric acid (H₂SO₄). The sulfuric acid may be neutralized with a basic material (e.g., NaOH, Na₂CO₃, Ca(OH)₂, etc.). In some embodiments, SOₓ gases in the flue gas can be reduced using dry scrubbing techniques. In dry scrubbing, solid particles (e.g., Ca(OH)₂, Na₂CO₃, CaCO₃, etc.) or a slurry thereof may react with the SOₓ gases to produce particulate matter (e.g., CaSO₃, Na₂SO₃).

In some embodiments, compressor 104 can compress gas (e.g., air) to feed to selective catalytic reduction system 106. In some embodiments, compressor 104 may comprise a horizontal or vertical compressor with a tank. In some embodiments, compressor 104 can operate at ambient temperature. In some embodiments, the compressor can compress gas up to at least about 50 psig, at least about 60 psig, at least about 70 psig, or at least about 80 psig. In some embodiments, the compressor can compress gas up to at most about 110 psig, at most about 100 psig, at most about 90 psig, or at most about 80 psig. In some embodiments, the compressed gas may be fed to selective catalytic reduction system 106 to provide additional O₂ for an oxidation catalyst contained within selective catalytic reduction system 106 to reduce volatile organic compounds or CO in the flue gas. The compressed gas may also serve as a purge to clean the catalyst pores of one or more catalysts in SCR system 106.

In some embodiments, selective catalytic reduction (SCR) system 106 comprises a reducing agent to selectively reduce NOₓ gases to N₂ gas (and water) with the aid of one or more catalysts. In some embodiments, a flue gas from a boiler of burner-boiler system 102 and compressed air from compressor 104 can be received at one or more inlets of SCR system 106. In some embodiments, a reducing agent from storage tank 112 can also be fed to an inlet of SCR system 106 to facilitate the reduction of NOₓ gases in the flue gas to N₂. In some embodiments, the reducing agent can comprise ammonia or urea. In some embodiments, the reducing agent and flue gas can be mixed prior to entering SCR system 106.

In some embodiments, SCR system 106 comprises one or more catalysts to facilitate the reduction reaction. In some embodiments, the catalyst(s) may comprise copper zeolite and/or iron zeolite. In some embodiments, the flue gas may comprise CO and volatile organic compounds (VOCs). In some embodiments, an oxidation catalyst may be included to oxidize CO and break down the VOCs. In some embodiments, the oxidation catalyst is a platinum-based catalyst. In some embodiments, the one or more catalysts may be held in a stainless-steel housing unit within SCR system 106.

In some embodiments, SCR system 106 comprises a controller 108 to regulate the amount of reducing agent fed to the system from storage tank 112. In some embodiments, controller 108 comprises a carbon steel frame and a screen. In some embodiments, controller 108 can be connectively coupled to one or more temperature sensors and one or more NOₓ sensors 110.

In some embodiments, SCR system 106 comprises one or more NOₓ sensors 110. In some embodiments, the one or more NOₓ sensors 110 may be placed at an inlet and an outlet of SCR system 106 and connectively coupled to controller 108. In some embodiments, the sensors can monitor the amount of NOₓ entering and exiting SCR system 106 to determine a NOₓ content of the output gas from SCR system 106. In some embodiments, based on the amount of NOₓ observed using the sensors, controller 108 can be used to adjust the flow rate of reducing agent being released from storage tank 112 into SCR system 106. In some embodiments, monitoring and adjusting the reducing agent flow rate accordingly can reduce the amount of excess reducing agent that passes through SCR system 106 unreacted.

In some embodiments, the output gas from SCR system 106 can be fed to an inlet of water removal system 114. In some embodiments, water removal system 114 can remove liquid water from the output gas from SCR system 106, leaving the remaining components of the output in gaseous form. In some embodiments, water removal system 114 can be a tricthylene glycol (TEG) dehydration system and/or a desiccant dryer. In some embodiments, water removal system 114 can be a heat exchanger. In some embodiments, water may be removed before feeding the output gas from SCR system 106 to gas separation membrane 118 because moisture condensing in the membrane can cause fouling. In some embodiments, feeding the output gas from SCR system 106 to water removal system 114 before compressor 116 may reduce the energy required to operate compressor 116. In some embodiments, before water removal, the output gas from SCR system 106 can be about 10-1000° C., about 50-500° C., about 100-300° C., about 150-250° C., or about 200° C. In some embodiments, before water removal, the output gas from SCR system 106 can be about ambient pressure or about 0.1-10 psig, about 1-10 psig, about 2-9 psig, about 4-6 psig, or about 5 psig.

In some embodiments, the output gas from water removal system 114 is about 0-50° C., about 1-30° C., about 2-20° C., about 3-10° C., about 4-6° C., or about 5° C. In some embodiments, the output gas from water removal system 114 is about 0.1-10 psig, about 1-8 psig, about 2-5 psig, or about 3 psig. In some embodiments, the output gas from water removal system 114 can be fed to an inlet of compressor 116.

In some embodiments, compressor 116 compresses the output gas from water removal system 114 to about 10-500 psig, about 50-400 psig, about 100-400 psig, about 150-400 psig, about 200-350 psig, about 250-300 psig, or about 275 psig to produce a compressed output. In some embodiments, at this temperature and/or pressure, the compressed output may comprise a liquid (e.g., water) and a gaseous mixture comprising the other components of the output gas. In some embodiments, compressor 116 may be an industrial-sized compressor that can fit on a skid for transportation.

In some embodiments, compressor 116 may include an aftercooler. In some embodiments, the aftercooler may be placed on a skid for transportation with compressor 116. In some embodiments, the coolant used in the aftercooler is water. In some embodiments, the water may be around ambient temperature. The aftercooler may cool the temperature of the compressed output of compressor 116 to a desirable temperature for the input to gas separation membrane 118. In some embodiments, the aftercooler may cool the compressed output to below about 100° C., below about 90° C., below about 80° C., below about 70° C., below about 60° C., below about 50° C., or below about 40° C. In some embodiments, the aftercooler may cool the compressed output to about 1-100° C., about 10-80° C., about 20-60° C., about 30-50° C., about 35-45° C., or about 40° C.

In some embodiments, compressor 116 may be placed before water removal system 114, such that the output gas from SCR system 106 is received at an inlet of compressor 116, and the compressed output from compressor 116 is received at an inlet of water removal system 114. In some embodiments, if compressor 116 is used before water removal system 114, the output gas from SCR system 106 can be fed to an inlet of compressor 116. Compressor 116 may compress the output gas from SCR system 106 to about 10-500 psig, about 50-400 psig, about 100-400 psig, about 150-400 psig, about 200-350 psig, about 250-300 psig, or about 275 psig to produce a compressed output. In some embodiments, at this temperature and/or pressure, the compressed output may comprise a liquid (e.g., water) and a gaseous mixture comprising the other components of the output gas.

In some embodiments, if compressor 116 is used before water removal system 114, the compressed output can be received at an inlet of water removal system 114. In some embodiments, water removal system 116 can remove liquid water from the compressed output, leaving the remaining components of the compressed output in gaseous form. In some embodiments, water removal system 114 may also cool the compressed output to below about 100° C., below about 90° C., below about 80° C., below about 70° C., below about 60° C., or below about 50° C. In some embodiments, water removal system 114 may cool the compressed output to about 20-100° C., about 25-75° C., about 30-50° C., or about 40° C. In some embodiments, water removal system 114 may cool the compressed output to a desirable temperature for the input to gas separation membrane 118.

In some embodiments, the compressed output can be received at an inlet of gas separation membrane 118 and passed across the membrane. In some embodiments, gas separation membrane 118 can be a polymeric gas separation membrane. In some embodiments, gas separation membrane 118 can be a hollow fiber membrane. In some embodiments, the membrane fibers may be contained within one or more cylindrical capsules.

In some embodiments, passing the compressed output over gas separation membrane 118 separates the gas into a retentate rich in N₂ and a permeate depleted in N₂ as compared to the retentate. In some embodiments, the retentate pressure is about 10-500 psig, about 50-400 psig, about 100-400 psig, about 150-400 psig, about 200-350 psig, about 250-300 psig, or about 275 psig and the permeate pressure is about 0.1-10 psig, about 1-10 psig, about 2-9 psig, about 4-6 psig, about 4-5 psig, or about 4.4 psig. In some embodiments, the retentate temperature is about 1-100° C., about 10-80° C., about 20-60° C., about 30-50° C., about 35-45° C., or about 40° C., and the permeate temperature is about 1-100° C., about 10-80° C., about 20-60° C., about 30-50° C., about 35-45° C., or about 40° C.

In some embodiments, the retentate comprises one or more of N₂, CO₂, CO, CH₄, C₂H₆, O₂, Ar, or NOₓ. In some embodiments, the retentate may comprise about 80-99.99% nitrogen by weight or about 85-99% N₂ by weight. In some embodiments, the retentate may comprise at most about 99.99 wt. %, at most about 99.5 wt. %, at most about 99 wt. %, at most about 98 wt. %, at most about 97 wt. %, at most about 96 wt. %, at most about 95 wt. %, at most about 90 wt. %, or at most 85 wt. % nitrogen. In some embodiments, the retentate may comprise at least about 50 wt. %, at least about 55 wt. %, at least about 60 wt. %, at least about 65 wt. %, at least about 70 wt. %, at least about 75 wt. %, at least about 80 wt. %, at least about 85 wt. %, at least about 86 wt. %, at least about 87 wt. %, at least about 88 wt. %, at least about 89 wt. %, at least about 90 wt. %, at least about 92 wt. %, or at least about 95 wt. % nitrogen. In some embodiments, the retentate may be stored and sold for use in processes requiring high purity nitrogen gas.

In some embodiments, the permeate comprises one or more of N₂, CO₂, CO, CH₄, C₂H₆, H₂O, Ar, O₂, or NOₓ. In some embodiments, the permeate may comprise about 25-75%, about 25-50%, about 30-50%, or about 35-49% CO₂ by weight. In some embodiments, the permeate may comprise at most about 65 wt. %, at most about 60 wt. %, at most about 55 wt. %, at most about 50 wt. %, at most about 49 wt. %, at most about 48 wt. %, at most about 47 wt. %, at most about 45 wt. %, or at most 40 wt. % carbon dioxide. In some embodiments, the permeate may comprise at least about 25 wt. %, at least about 30 wt. %, at least about 35 wt. %, at least about 36 wt. %, at least about 37 wt. %, at least about 38 wt. %, at least about 39 wt. %, at least about 40 wt. %, at least about 41 wt. %, at least about 42 wt. %, at least about 43 wt. %, at least about 44 wt. %, at least about 45 wt. %, at least about 46 wt. %, or at least about 47 wt. % carbon dioxide.

In some embodiments, since the permeate is rich in CO₂, one or more additional steps may be undertaken to isolate CO₂ from the permeate for further processing or for use in applications requiring high purity CO₂ gas. In some embodiments, the permeate is fed to CO₂ separation system 120 instead of or in addition to being fed to sequestration system 122. In some embodiments, separation system 120 can separate the permeate into a CO₂ stream and a waste gas stream. In some embodiments, separation system 120 may use absorption techniques to isolate CO₂ from the other components of the permeate. In some embodiments, one or more liquid amine absorbents may be used to attract the CO₂ and separate it from the other components of the gas. In some embodiments, after the CO₂ is absorbed by the absorbent, a pure stream of CO₂ may be removed from the absorbent by increasing the temperature and/or pressure. In some embodiments, separation system 120 may use adsorption techniques to isolate CO₂ from the other components of the permeate. In some embodiments, CO₂ may adhere to the surface of one or more solid adsorbents, separating the CO₂ from the other components of the gas. In some embodiments, the solid adsorbents may be molecular sieves. In some embodiments, after the CO₂ is adsorbed by the adsorbent, a pure stream of CO₂ may be removed from the adsorbent by increasing the temperature and/or pressure.

In some embodiments, the CO₂ stream may be purified to about 90-99.99 wt. % or about 90-99.95 wt. % purity for industrial or food-grade use. In some embodiments, the CO₂ stream comprises at most about 99.99 wt. %, at most about 99.5 wt. %, at most about 99 wt. %, at most about 98 wt. %, at most about 97 wt. %, at most about 96 wt. %, at most about 95 wt. %, or at most about 90 wt. % carbon dioxide. In some embodiments, the CO₂ stream may comprise at least about 90 wt. %, at least about 91 wt. %, at least about 92 wt. %, at least about 93 wt. %, at least about 94 wt. %, at least about 95 wt. %, at least about 96 wt. %, at least about 97 wt. %, at least about 98 wt. %, or at least about 99 wt. % carbon dioxide.

In some embodiments, CO₂ separation system 120 may use membrane techniques to isolate CO₂ from the other components of the permeate of gas separation membrane 118. In some embodiments, the permeate from gas separation membrane 118 can be received at an inlet of a CO₂-selective gas separation membrane of CO₂ separation system 120 and passed across the membrane. In some embodiments, the CO₂-selective gas separation membrane can be a facilitated transport membrane. In some embodiments, the facilitated transport membrane can include one or more amine carrier agents. In some embodiments, passing the permeate from gas separation membrane 118 over the CO₂-selective gas separation membrane separates the gas into a permeate rich in CO₂ and a retentate depleted in CO₂ as compared to the permeate.

In some embodiments, the CO₂-rich permeate from the CO₂-selective gas separation membrane may comprise one or more of N₂, CO₂, CO, CH₄, C₂H₆, H₂O, Ar, O₂, or NOₓ. In some embodiments, the permeate from the CO₂-selective gas separation membrane may comprise about 92-99% wt. CO₂. In some embodiments, the permeate from the CO₂-selective gas separation membrane may comprise at most about 99%, at most about 98%, at most about 97%, at most about 96%, at most about 95%, at most about 94%, or at most about 93% wt. CO₂. In some embodiments, the permeate from the CO₂-selective gas separation membrane may comprise at least about 92%, at least about 93%, at least about 94%, at least about 95%, at least about 96%, at least about 97%, or at least about 98% wt. CO₂. In some embodiments, the pressure of the permeate from the CO₂-selective gas separation membrane is about 0-10 psig, about 0-5 psig, about 0-1 psig, or about ambient pressure. In some embodiments, the temperature of the permeate from the CO₂-selective gas separation membrane is about 1-100° C., about 10-80° C., about 20-60° C., about 30-50° C., about 35-45° C., or about 40° C.

In some embodiments, the CO₂-depleted retentate from the CO₂-selective gas separation membrane may comprise one or more of N₂, CO₂, CO, CH₄, C₂H₆, H₂O, Ar, O₂, or NOₓ. In some embodiments, the pressure of the retentate from the CO₂-selective gas separation membrane is about 0.1-10 psig, about 1-10 psig, about 2-9 psig, about 4-6 psig, about 4-5 psig, or about 4.4 psig. In some embodiments, the temperature of the retentate from the CO₂-selective gas separation membrane is about 1-100° C., about 10-80° C., about 20-60° C., about 30-50° C., about 35-45° C., or about 40° C. In some embodiments, the CO₂-depeleted retentate can be exhausted into the atmosphere.

In some embodiments, the permeate from gas separation membrane 118 is fed to sequestration system 122 instead of or in addition to being fed to CO₂ separation system 120. In some embodiments, sequestration system 122 sequesters the permeate from gas separation membrane 118 into a ground injection site. In some embodiments, sequestration system 122 may comprise an injection well and a conduit to transmit the permeate from gas separation membrane 118 into the injection well. In some embodiments, an injection well may be drilled near the CO₂ production facility, or an existing injection well may be used. In some embodiments, the conduit used to transmit the CO₂ to the injection well may be a pipeline. In some embodiments, the CO₂ is transported to the well in a liquid state. In some embodiments, the CO₂ is transported to the well in a gaseous state.

Specific examples of systems and methods for obtaining nitrogen gas from a flue gas according to some embodiments are further described below.

### EXAMPLES

### Example 1: Obtaining Nitrogen from a Flue Gas Produced from a Biomass Input

Biomass pyrolysis was conducted around 1000° C. and 5 psig using 186.71 kg/h dry biomass to produce a pyrolysis gas. The pyrolysis gas was produced by pyrolyzing and gasifying wood chips. The resulting pyrolysis gas comprised 2.00 kg/h H₂, 94.00 kg/h N₂, 72.55 kg/h CO₂, 40.02 kg/h CO, 8.81 kg/h CH₄, 13.22 kg/h C₂H₆, 3.30 kg/h primary tars, 3.10 kg/h secondary tars, 44.18 kg/h H₂O, and 1.60 kg/h Ar. The primary tars were assumed to be acetic acid, and the secondary tars were assumed to be phenol. The pyrolysis gas flow rate was calculated by combining the air used for gasification and all of the volatiles released from the dry biomass. All gases, including the pyrolysis gas, were assumed to behave as ideal gases.

TABLE 1
Pyrolysis Gas Composition

| Compound | Mass flow (kg/h) | Weight % |
|---|---|---|
| H₂ | 2.00 | 0.71% |
| N₂ | 94.00 | 33.24% |
| CO₂ | 72.55 | 25.66% |
| CO | 40.02 | 14.15% |
| CH₄ | 8.81 | 3.12% |
| C₂H₆ | 13.22 | 4.67% |
| Primary Tars | 3.30 | 1.17% |
| Secondary tars | 3.10 | 1.10% |
| H₂O | 44.18 | 15.62% |
| Ar | 1.60 | 0.57% |

The pyrolysis gas was mixed with 636.77 kg/h combustion air at ambient conditions. The combustion air comprised 480.86 kg/h N₂, 0.39 kg/h CO₂, 147.35 kg/h O₂, and 8.17 kg/h Ar. The combustion air was fed at 20% excess.

TABLE 2
Combustion Air Composition

| Compound | Mass flow (kg/h) | Weight % |
|---|---|---|
| N₂ | 480.86 | 75.52% |
| CO₂ | 0.39 | 0.06% |
| O₂ | 147.35 | 23.14% |
| Ar | 8.17 | 1.28% |

The mixture of pyrolysis gas and combustion air was introduced into a boiler system and burned. The primary and secondary tars were removed via filtration before the mixture entered the boiler system. The boiler had a power rating of 0.5 MW and operated around 85% efficiency. The flue gas produced by the boiler system comprised 574.83 kg/h N₂, 197.49 kg/h CO₂, 0.736 kg/h CO, 0.007 kg/h CH₄, 0.007 kg/h C₂H₆, 105.54 kg/h H₂O, 24.72 kg/h O₂, 9.77 kg/h Ar, 0.12 kg/h NOₓ, and 0.04 kg/h SO₂. All NOₓ was assumed to be NO₂. NOₓ, CO, and VOC emissions were calculated from emission factors.

TABLE 3
Flue Gas Composition

| Compound | Mass flow (kg/h) | Weight % |
|---|---|---|
| N₂ | 574.83 | 62.94% |
| CO₂ | 197.49 | 21.62% |
| CO | 0.736 | 0.08% |
| CH₄ | 0.007 | 0.00075% |
| C₂H₆ | 0.007 | 0.00075% |
| H₂O | 105.54 | 11.56% |
| O₂ | 24.72 | 2.71% |
| Ar | 9.77 | 1.07% |
| NOₓ | 0.12 | 0.014% |
| SO₂ | 0.04 | 0.0041% |

The flue gas was fed to the selective catalytic reduction (SCR) system. 16.37 kg/h compressed air at 80 psig was also fed to the SCR system. Ammonia was used as the reducing agent for the SCR system. 0.18 kg/h aqueous ammonia was fed to the SCR system. Ammonia was fed in an amount stoichiometrically equivalent to the amount of NOₓ.

In the SCR system, NO₂ was reduced to N₂ and H₂O by the ammonia. CO, CH₄, and C₂H₆ also reacted with O₂ in the SCR system to produce CO₂ and H₂O, as illustrated below:

$$\begin{matrix}\frac{1}{2} \frac{7}{2} 6 {NO}_{2} + 8 {NH}_{3} ⟶ 7 {N}_{2} + 12 {H}_{2} O \\ \frac{1}{2} \frac{7}{2} CO + {O}_{2} ⟶ {CO}_{2} \\ \frac{1}{2} \frac{7}{2} {CH}_{4} + 2 {O}_{2} ⟶ {CO}_{2} + 2 {H}_{2} O \\ \frac{1}{2} \frac{7}{2} {C}_{2} {H}_{6} + {O}_{2} ⟶ 2 C {O}_{2} + 3 {H}_{2} O\end{matrix}$$

The output of the SCR system comprised 587.27 kg/h N₂, 198.57 kg/h CO₂, 0.07 kg/h CO, 0.0014 kg/h CH₄, 0.0014 kg/h C₂H₆, 105.65 kg/h H₂O, 28.09 kg/h O₂, 9.98 kg/h Ar, 0.019 kg/h NOₓ, and 0.037 kg/h SO₂. The reduction efficiency of the SCR system was 85% for NOₓ, 90% for CO, 80% for CH₄, and 80% for C₂H₆. The reduction efficiency of the SCR system was based on reduction efficiencies of typical SCR operations.

TABLE 4
SCR Output Composition

| Compound | Mass flow (kg/h) | Weight % |
|---|---|---|
| N₂ | 587.27 | 63.17% |
| CO₂ | 198.57 | 21.36% |
| CO | 0.07 | 0.0079% |
| CH₄ | 0.0014 | 0.00015% |
| C₂H₆ | 0.0014 | 0.00015% |
| H₂O | 105.65 | 11.36% |
| O₂ | 28.09 | 3.02% |
| Ar | 9.98 | 1.07% |
| NOₓ | 0.019 | 0.0020% |
| SO₂ | 0.037 | 0.0040% |

The output from the SCR system was treated before being transmitted to a nitrogen-selective gas separation membrane. The SCR system output was received by a water removal system, which removed liquid water from the SCR system output. The dried output was then fed to a compressor that compressed the dried output to 275 psig. The dried compressed output comprised 587.27 kg/h N₂, 198.57 kg/h CO₂, 0.07 kg/h CO, 0.0014 kg/h CH₄, 0.0014 kg/h C₂H₆, 0.85 kg/h H₂O, 28.09 kg/h O₂, 9.98 kg/h Ar, 0.019 kg/h NOₓ, and 0.037 kg/h SO₂.

TABLE 5
Dried Compressed Output (Membrane Input) Composition

| Compound | Mass flow (kg/h) | Weight % |
|---|---|---|
| N₂ | 587.27 | 71.19% |
| CO₂ | 198.57 | 24.07% |
| CO | 0.07 | 0.0089% |
| CH₄ | 0.0014 | 0.00016% |
| C₂H₆ | 0.0014 | 0.00016% |
| H₂O | 0.85 | 0.10% |
| O₂ | 28.09 | 3.41% |
| Ar | 9.98 | 1.21% |
| NOₓ | 0.019 | 0.0022% |
| SO₂ | 0.037 | 0.0045% |

The dried compressed output was passed over a nitrogen-selective gas separation membrane. The gas separation membrane was a hollow fiber membrane. The membrane separated the gas into an N₂-rich retentate and a CO₂-rich permeate. The membrane separation was modeled from membranes currently in operation.

The retentate was 99.42% N₂ by weight. The retentate comprised 425.53 kg/h N₂, 0.71 kg/h CO₂, 0.048 kg/h CO, 0.001 kg/h CH₄, 0.001 kg/h C₂H₆, 0.36 kg/h O₂, 1.37 kg/h Ar, and 0.008 kg/h NOₓ.

TABLE 6
Retentate Composition

| Compound | Mass flow (kg/h) | Weight % |
|---|---|---|
| N₂ | 425.53 | 99.42% |
| CO₂ | 0.71 | 0.17% |
| CO | 0.048 | 0.011% |
| CH₄ | 0.001 | 0.0003% |
| C₂H₆ | 0.001 | 0.0003% |
| H₂O | 0.00 | 0 |
| O₂ | 0.36 | 0.085% |
| Ar | 1.37 | 0.32% |
| NOₓ | 0.008 | 0.0018% |

The permeate was 51.84% CO₂ by weight. The permeate comprised 161.73 kg/h N₂, 197.86 kg/h CO₂, 0.026 kg/h CO, 0.000068 kg/h CH₄, 0.000014 kg/h C₂H₆, 0.85 kg/h H₂O, 27.72 kg/h O₂, 8.61 kg/h Ar, and 0.018 kg/h NOₓ.

TABLE 7
Permeate Composition

| Compound | Mass flow (kg/h) | Weight % |
|---|---|---|
| N₂ | 161.73 | 39.14% |
| CO₂ | 197.86 | 51.84% |
| CO | 0.026 | 0.0065% |
| CH₄ | 0.000068 | 0.000017% |
| C₂H₆ | 0.000014 | 0.0000034% |
| H₂O | 0.85 | 0.27% |
| O₂ | 27.72 | 6.66% |
| Ar | 8.61 | 2.08% |
| NOₓ | 0.018 | 0.0033% |

The permeate can be passed over a CO₂-selective gas separation membrane to further separate the permeate from the first gas separation membrane into a CO₂-rich permeate and a CO₂-poor retentate as compared to the permeate.

This application discloses several numerical ranges in the text and FIGURES. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. Finally, the entire disclosure of the patents and publications referred in this application are hereby incorporated herein by reference.

1. A method for obtaining nitrogen gas from a flue gas, comprising:
receiving a flue gas at an inlet of a selective catalytic reduction system, wherein the flue gas comprises one or more NOₓ gases;
reducing the one or more NOₓ gases to N₂ gas in the selective catalytic reduction system;
receiving an output gas from the selective catalytic reduction system at an inlet of a gas separation membrane; and
separating the output gas into a retentate and a permeate using the gas separation membrane, wherein the retentate comprises N₂ gas.

2. The method of claim 1, wherein a source of the flue gas is a pyrolysis gas, a biogas, or a methane gas.

3. The method of claim 2, further comprising:
burning methane gas in a burner-boiler system;
producing a flue gas; and
transmitting the flue gas to the inlet of the selective catalytic reduction system.

4. The method of claim 1, wherein the flue gas comprises one or more of NOₓ, N₂, CO₂, CO, H₂O, O₂, CH₄, C₂H₆, Ar, SO₂, or volatile organic compounds.

5. The method of claim 1, wherein the selective catalytic reduction system comprises a reducing agent.

6. The method of claim 5, wherein the reducing agent comprises ammonia or urea.

7. The method of claim 1, wherein the selective catalytic reduction system comprises a copper zeolite catalyst, an iron zeolite catalyst, or a platinum-based oxidation catalyst.

8. The method of claim 1, wherein the selective catalytic reduction system comprises one or more NOₓ sensors, wherein the NOₓ sensors determine a NOₓ content of the output gas from the selective catalytic reduction system.

9. The method of claim 8, wherein the selective catalytic reduction system comprises a controller configured to adjust a flow rate of a reducing agent based on the determined NOₓ content from the one or more NOₓ sensors.

10. The method of claim 1, further comprising:
removing water from the output gas from the selective catalytic reduction system;
compressing the output gas into a compressed output; and
receiving the compressed output at an inlet of the gas separation membrane.

11. The method of claim 1, wherein the retentate comprises at least 85% wt. N₂.

12. The method of claim 1, wherein the permeate comprises at least 35% wt. CO₂.

13. The method of claim 1, wherein the permeate comprises one or more of N₂, CO₂, CO, CH₄, C₂H₆, H₂O, Ar, O₂, or NOₓ.

14. The method of claim 1, further comprising sequestering the permeate into a ground injection site.

15. The method of claim 1, further comprising separating the permeate into a CO₂ stream and a waste gas stream.

16. The method of claim 15, wherein separating the permeate into a CO₂ stream and a waste gas stream comprises:
receiving the permeate at an inlet of a CO₂-selective gas separation membrane; and
separating the permeate into a waste gas stream comprising a CO₂-poor retentate and a CO₂ stream comprising a CO₂-rich permeate using the CO₂-selective gas separation membrane, wherein the CO₂-rich permeate comprises CO₂ gas.

17. A system for obtaining nitrogen gas from a flue gas, comprising:
a selective catalytic reduction system configured to:
receive a flue gas at an inlet of the selective catalytic reduction system, wherein the flue gas comprises one or more NOₓ gases; and
reduce the one or more NOₓ gases to N₂ gas; and
a gas separation membrane configured to:
receive an output gas from the selective catalytic reduction system at an inlet of the gas separation membrane; and
separate the output gas into a retentate and a permeate, wherein the retentate comprises N₂ gas.

18. The system of claim 17, further comprising a burner-boiler system configured to:
produce the flue gas; and
transmit the flue gas to an inlet of the selective catalytic reduction system.

19. The system of claim 17, further comprising a water removal system configured to:
receive the output gas from the selective catalytic reduction system at an inlet of the water removal system; and
remove water from the output gas from the selective catalytic reduction system to produce a dried output gas.

20. The system of claim 19, further comprising a compressor configured to:
receive the dried output gas at an inlet of the compressor;
compress the dried output gas into a compressed output; and
transmit the compressed output from an outlet of the compressor to an inlet of the gas separation membrane.
